(19) United States
(12) Patent Application Publication
(10) Pub. No.: US 2006/0269626 A1
(43) Pub. Date: Nov. 30, 2006

(54) Elicitor made from trigonella foenum graecum extracts for the treatment of plant pathogens, use thereof, and method for the production thereof

(76) Inventors: Christelle Martinez, Port La Nouvelle (FR); Jean-Claude Baccou, Montpeller Cedex (FR); Lucien Delpech, Port La Nouvelle (FR); Michel Delrieux, Port La Nouvelle (FR); Henri Cassan, Narbonne (FR)

Correspondence Address: EGBERT LAW OFFICES, 412 MAIN STREET, 7TH FLOOR, HOUSTON, TX, 77002, US

(21) Appl. No.: 10/559,003

(22) PCT Filed: Jun. 10, 2004
(86) PCT No.: PCT/EP04/51083

§ 371 Date: Mar. 23, 2006

(30) Foreign Application Priority Data
Jun. 10, 2003 (FR) 0306957

(51) Int. Cl. A01N 63/00; A01N 65/00

(52) U.S. Cl. 424/757; 504/117

(57) ABSTRACT

The method for preparing a novel elicitor or agent stimulating the defenses of plants against pathogens is applied to agronomically useful plants in order to control pathogens. The elicitor is prepared without extraction by a liquid from a dry product made of Trigonella foenum graecum seeds. The inventive method preferably includes the following steps: separating the germ fraction and cotyledon of the seed; grinding the fraction so as to obtain a powder; and solubilizing the powder in water, whereupon the obtained solution is sprayed onto the plant/s that is/are to be treated.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### Field of the Invention

This invention concerns a plant treatment product, the use thereof and a method for the production thereof. It applies more specifically to the control of pathogens and any kinds of plant parasites (fungi, bacteria, viruses, insects, etc.) using a new stimulator of the plant natural defenses or elicitor. The new product composition is active on a preventive and curative basis and comprises the implementation of a fenugreek extract or Trigonella foenum graecum without extraction liquid in phase.

### BACKGROUND OF THE INVENTION

Plants are continuously subject to parasitic pressure from numerous pathogens such as viruses, bacteria, fungi or insects. The plant resistance to a pathogen results either from the identification of the pathogen by the plant (gene per gene relation), or from the stimulation of the defenses under the effect of injuries caused by the parasite.

In the first case, the resistance results from the identification of the pathogen carrying a specific gene called “avirulence gene” by the plant equipped with the corresponding “resistance gene”. In this case, a true genetically programmed interactive relation exists between the plant and the parasite.

After identification of the two protagonists, specific mechanisms are then developed by the plant (cascade of metabolic events, synthesis of resistance messenger signals), giving it a resistance characteristic while the invasion of the host tissues by the pathogen remains very localized.

In the second case, the defense mechanisms are induced, for example during fungous attacks by the oligosaccharides resulting from degradation of the fungus walls under the action of the host hydrolases on one hand, and of the walls of the hydrolyzed cells by the fungus enzymes on the other hand. These wall debris also act as resistance messengers.

After a first trigger of the resistance mechanisms, plants can develop an increased resistance against new parasite attacks, specifically in the non infected parts of the plant thanks again to certain “natural chemical messengers.” This mechanism is called “Acquired Systemic Resistance.”

Whenever a plant is sensible to a pathogen, it is incapable of identifying its aggressor either through the gene per gene relation, or through the “injury” effect. It is then incapable of efficiently activating its defense genes. It is possible to stimulate the natural defenses of plants by supplying in an exogenous manner these “natural chemical signals” of the resistance that they are incapable of producing in some cases with regard to certain pathogens.

Whenever there is identification between the plant and the pathogen, special mechanisms are developed by the plant. The plant often responds by the onset of cellular necrosis on the site of attack by the pathogen and thus blocks its progression. This defense reaction is almost always associated with the implementation of mechanisms such as biosynthesis of phytalexins (antifungal molecules), defense enzymes such as peroxidases or proteins in connection with pathogenesis (PR proteins) such as chitinases or P-1,4-endoglucanases. These enzymes are capable of lyzing the fungous and bacterial walls. Whenever there is resistance, the plants are capable of reinforcing the cellular walls (lignin synthesis) to block the pathogen on its penetration site.

A process is well known for the stimulation of the natural defenses of agronomically useful plants, which includes the application to such plants of an elicitor or sensitizer that is capable upon contact with the plants to preventively cause in said plants activation of the defense genes on the product application site as well as acquired systemic resistance. Such process is more specifically described in the French patent application filed Jul. 18, 1997 under U.S. Pat. No. 2,766,059 by GOEMAR Laboratories. This process uses an efficient quantity of an oligo P 1-3-glucane.

It is prepared from β 1-3-glucanes of various origins that are hydrolyzed into oligo P 1-3-glucanes. The β 1-3-glucanes come from bacteria, including Alcaligenes faecalis, from fungi, including Schizophyllum and Sclerotium glucanium, from yeasts, including Saccharomyces cerevisae, from algae and cereals.

However, this process does not permit to cause resistance of a same plant several times in a row. Only one spraying is possible. This process is thus mainly preventive and time-limited.

In the U.S. Patent granted on Nov. 2, 1999 to EDEN Bioscience under U.S. Pat. No. 5,977,060, a method was described to control the action of insects on plants. In that patent, numerous references are cited regarding elicitors for plant defensive systems against insects, which can be referred to. This process is an insect control process for plants that consists of applying a polypeptide or protein elicitor to a plant or a seed under efficient conditions to control insects. The (polypeptide or protein) elicitor causing the hypersensitive response corresponds to that achieved from a pathogen selected in the group comprising Erwinia, Pseudomonas, Xanthomonas, Phyrophtora and their mixtures. In one embodiment, the elicitor can be applied to plants by applying a bacterium containing genes capable of secreting or exporting the polypeptide or protein. The bacterium does not cause the disease and was transformed (for example in a recombinant manner) by genes encoding a hypersensitive response eliciting polypeptide or protein. That document thus describes a method to control insects and not pathogens in general. In addition, that document refers to genetic manipulations that are very ill perceived by the public.

In addition, fenugreek seeds are well known, which are used in the agro-industry as a spice and in the pharmaceutical industry. Fenugreek or Trigonella foenum graecum or also Senegrain is a legume from the pea family. Fenugreek contains an essential oil consisting of 40 different compounds out of which 3-hydroxy-4,5-dimethyl-oxolane-2-one seems to be the major aromatic component. Among the non-volatile components it contains, furostanol glycosides, sterols and steroidal saponins were identified as offering a potential interest for the pharmaceutical industry.

In the US patent granted on 7 Dec. 1999 to Emerald Seed Products Ltd. Company under U.S. Pat. No. 5,997,877, a method of extraction of commercially reasonable fenugreek seed fractions was described. The fenugreek seeds contain a yellow central core that is the cotyledon and the germ surrounded by white and semi-transparent endosperm and tegument. Said endosperm contains guar gums and is surrounded by a dark brown rind. The gum and oleoresin retrieval method consists of wetting the fenugreek seeds within a range of 14%-20% of moisture; crushing the fenugreek seeds; mixing the crushed seeds with a solvent for such contact period at such temperature that some seed components are absorbed by the solvent; separating the solvent extract. The disadvantage of this method is that it uses a solvent that is a polar alcohol. Another method is described in this U.S. Pat. No. 5,997,877 that consists of recovering the soluble fibers. For that purpose, seeds are crushed, screened ant the heavy part made of tegument and biofilm (shell) is retrieved. Said heavy part is then treated with hot water, which makes it possible to retrieve the soluble fibers. The gums contained in the light part are then retrieved using a solvent.

The disadvantage of the state of the art cited above is that the product achieved from Trigonella foenum graecum is obtained through extraction using an alcohol solvent that is not neutral on the final product and can thus have harmful effects on the plant. That is the case for the state of the art consisting of documents DE 197266, EP 0493670 or DATABASE NO 1994-84121 or XP 002 194 376 or Chemical Abstract Vol 119 N° 11 (1993-9-13) Krata.

A technological advance contained in patent FR 01 07898 by the same applicants consists of using Trigonella foenum graecum seed from which extracts are obtained by crushing the seeds, separating the protection of the cotyledon and germ fraction, and extracting the elicitor components of this germ and cotyledon fraction with water during a filtration operation.

### BRIEF SUMMARY OF THE INVENTION

The purpose of this invention is to control pathogens and all kinds of plant parasites (fungi, viruses, bacteria, insects, etc.) using a new eliciting product (stimulating the plant defenses against pathogens), the latter allowing for both preventive and curative actions.

Another purpose of this invention is to provide for the use of an elicitor, said use making it possible to obtain a phytosanitary product having an eliciting function.

A further purpose of this invention is to provide a new elicitor preparation method, such method making it possible to obtain an elicitor that is not aggressive with regard to the treated plant and the environment.

The inventors have discovered after lab tests that dry extracts derived from fenugreek treatment have the property of significantly stimulating various enzymatic activities involved in the plant defense mechanisms against pathogens and all kinds of plant parasites (fungi, bacteria, viruses, insects, etc.)

The inventors noticed after lab tests that the same effects were achieved when the cotyledon and germ fraction of said seed was crushed into powder and mixed with water to obtain a solution to be projected onto plants. The advantage of this method is not to have to go through a liquid product phase, which permits to avoid fermentation of the product and to market a powder that will be added to a solution only at the time of use and at the time of packaging of the product, the extraction of its active ingredients being done only when it is added to a solution. The powder can also been projected directly onto the plants (dusting) or be incorporated in the fabrication of a phytosanitary product.

This invention has another advantage: the crushing of the seed without having to go through a water extraction phase permits to keep intact all molecules contained in the fenugreek, such as for example the saponins and dextrins contained in the germ and cotyledon fraction and in the powder obtained. The saponins have a wetting effect on the plant leaves, which increases the elicitor efficiency and the dextrins have an adhering effect that affixes the solution and its active compounds onto the plant, as commonly done in the agricultural field. The plants withstand repeated elicitor treatments and the plant defense mechanisms are stimulated upon each treatment.

The dry extract of Trigonella foenum graecum seeds is preferably obtained with a method consisting of crushing the seeds, separating the cotyledon and germ fraction from the tegument and biofilm fraction. The cotyledon and germ fraction is crushed again so as to obtain a powder with a grain size of preferably less than 200 microns. The particles obtained through crushing and screening or micronizing can range from 5 to 500 microns.

According to a first aspect, this invention concerns a plant treatment product, characterized in that it comprises a dry product obtained through extraction without liquid from Trigonella foenum graecum (fenugreek).

According to special characteristics, the dry product obtained from Trigonella foenum graecum (fenugreek) is suitable to be mixed with at least one liquid carrier before use.

According to special characteristics, in the plant treatment product such as briefly outlined above, the dry product obtained from Trigonella foenum graecum (fenugreek) comprises at least two active molecules derived from the fenugreek.

According to special characteristics, in the plant treatment product such as briefly outlined above, the dry product obtained from Trigonella foenum graecum (fenugreek) comprises at least one active molecule of more than 30,000 Dalton and at least one active molecule of less than 30,000 Dalton.

According to special characteristics, in the plant treatment product such as briefly outlined above, the dry product obtained from Trigonella foenum graecum (fenugreek) is, at least in part, obtained from the seed of the fenugreek plant.

According to special characteristics, in the plant treatment product such as briefly outlined above, the dry product obtained from Trigonella foenum graecum (fenugreek) is, at least in part, obtained from the aerial part of the fenugreek plant.

According to special characteristics, in the plant treatment product such as briefly outlined above, the dry product obtained from Trigonella foenum graecum (fenugreek) is obtained, at least in part, from the root of the fenugreek plant.

According to special characteristics, the dry product obtained from Trigonella foenum graecum comes in any form of powder alone, pellets alone or in combination with other formulation products. According to special characteristics, the dry product obtained from Trigonella foenum graecum is combined with wetting, dispersing and/or adhering agents.

According to special characteristics, the dry product obtained from Trigonella foenum graecum is combined with other treatment products among the following: fungicides, bactericides, antivirals, insecticides, other defense stimulators and/or fertilizers.

According to special characteristics, the plant treatment product such as briefly outlined above, is suitable to act on the early development of plants and crops.

According to special characteristics, the plant treatment product such as briefly outlined above is suitable to act on the development of mycotoxins in the products obtained after the harvest.

According to a second aspect, this invention concerns the use of a plant treatment product such as briefly outlined above, for the fabrication of a phytosanitary compound designed to stimulate plant defenses.

According to a third aspect, this invention concerns the use of a plant treatment product such as briefly outlined above, for the fabrication of a phytosanitary compound designed to act on the early development of plants.

According to a fourth aspect, this invention concerns the use of a plant treatment product such as briefly outlined above, for the fabrication of a phytosanitary compound designed to act against the development of mycotoxins in the plants harvested.

According to a fifth aspect, this invention concerns a method for obtaining a plant treatment product such as briefly outlined above, characterized in that it comprises an extraction step through separation without liquid of a dry product from Trigonella foenum graecum (fenugreek).

According to special characteristics, the method for obtaining a plant treatment product such as briefly outlined above, comprises a powder reduction step of the base material.

According to special characteristics, the method for obtaining a plant treatment product such as briefly outlined above, comprises:
a fenugreek crushing step,
a separation step of the germ and cotyledon fraction from the tegument and biofilm fraction,
a re-crushing step of the germ and cotyledon fraction to obtain a powder of a predetermined grain size that can be stored in a stable manner, and
a solubilization step of said powder in water.

According to special characteristics, the method for obtaining a plant treatment product such as briefly outlined above, comprises a screening step of the germ and cotyledon fraction to obtain particles from 5 microns to 500 microns.

### BRIEF DESCRIPTION OF THE SEVERAL VIEWS OF THE DRAWINGS

FIG. 1 is a schematic view of an illustration of a succession of steps for the production of a plant treatment product under a special embodiment of the method under this invention.

### DETAILED DESCRIPTION OF THE INVENTION

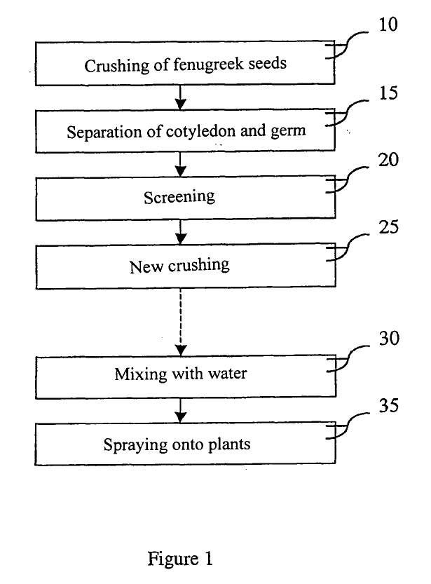

This invention will now be described in further detail using the following examples that are not in any case designed to limit the scope of this invention and using FIG. 1 that describes a succession of steps for the production of a plant treatment product under a special embodiment of the method under this invention.

### EXAMPLES

### Example 1

Method for the extraction of the new elicitor. Fenugreek seeds are used that are crushed (step 10) so as to obtain a powder. The cotyledon and germ fraction is separated from the tegument and biofilm fraction (step 15) using a densitometer method. The cotyledon and germ faction is eventually screened (step 20) to obtain particles from 5 microns to 500 microns and re-crushed (step 25) so as to obtain a powder of a grain size of preferably less than 200 μm.

In the embodiment shown in FIG. 1, between 1 and 100 grams, but preferably 5 grams of this powder are mixed with 1 liter of water (step 30) and this solution is sprayed onto plants (step 35).

In an alternative design, step 30 is carried out when packaging the commercial product that comes then in liquid form. In another alternative design, step 30 is carried out by the user of the commercial product that then comes in the form of a powder.

In another alternative design, step 30 is not carried out and the plants are dusted directly with the powder obtained after step 25.

In an alternative design, the powder obtained after step 25 is incorporated in the formulation of a phytosanitary product fulfilling other functions than the sole eliciting function, for example one of the following functions: fungicides, bactericides, antivirals and/or insecticides, natural defense stimulator of plants and/or fertilizers.

The powder obtained after step 25 constitutes a plant treatment product, comprising a dry product obtained from Trigonella foenum graecum (fenugreek) comprising at least one active molecule. It is noted that this product is preferably designed to be mixed with at least one liquid carrier before use.

Thus, this invention is not limited to a plant treatment product coming in a powder or liquid form, but on the contrary applies to any plant treatment product obtained from a dry product itself obtained from Trigonella foenum graecum through separation or extraction without liquid, whether this product is then incorporated into a phytosanitary product, solubilized before packaging, solubilized after packaging and before use or left in a powder form for plant dusting.

The phytosanitary product, for the production of which the dry product obtained from Trigonella foenum graecum is used, can, for example, be designed to stimulate the plant defenses, so as to act on the early development of plants and/or to act against the development of mycotoxins in the harvested plants.

Thus, according to alternative designs, the dry product is formulated as powder, pellets alone or in combination with other formulation products, for example wetting dispersing and/or adhering agents, and/or other treatment products, for example among the following: fungicides, bactericides, antivirals, insecticides, other defense stimulators and/or fertilizers.

Preferably, the plant treatment product such as briefly outlined above, the dry product obtained from Trigonella foenum graecum (fenugreek), comprises at least two active molecules among the fenugreek active molecules. Preferably at least one active molecule is more than 30,000 Dalton and at least one active molecule is less than 30,000 Dalton.

The plant treatment product thus obtained is designed to stimulate plant the defenses de the plant, through an eliciting function.

Preferably, the plant treatment product thus obtained is designed to act on the early development of plants and harvest.

Preferably, the plant treatment product thus obtained is designed to act on the development of mycotoxins in the products obtained after harvest.

In the special embodiment described above, the dry product obtained from Trigonella foenum graecum (fenugreek) is, at least in part, obtained from the seed of the fenugreek plant.

In an alternative design, the dry product obtained from Trigonella foenum graecum (fenugreek) is, at least in part, obtained from the aerial part of the fenugreek plant and/or of the root of the fenugreek plant.

### Example 2

Treatment of vegetable and ornamental plants with fenugreek extract. The extract prepared in example 1 above is sprayed onto the following plants, and the resistance of various plants to different parasites is being tested. As an example, highly significant effects are obtained during preventive and curative treatments on the following plant/parasite pairs: melon/oidium; melon/bacteriose; melon/1 Thrips; melon/aleurodes; vine/oidium; vine/mildew, vine/excoriosis, rose bush/rust, rose bush/oidium, wheat/septoria leaf botch, wheat/oidium, etc.

These treated plants are compared to non-treated plants. In the case of preventive treatments, the treated plants are little or not at all attacked by the parasites (contrary to the non-treated plants), provided that treatment is regularly renewed. In the case of curative treatments, the treated plants see infection symptoms decrease after a few days after the first treatment with fenugreek extract. Treatment may be carried out on young plants, on cuttings, or on adult plants, as a matter of fact regardless of the growth stage of the plants.

It is to be noted that:
the inventors have discovered that the fenugreek powder has a strong plant defense stimulating action: it permits to protect practically any plants against practically all parasites;
the inventors have discovered an interesting secondary effect concerning early harvesting of the fruit and early production of all treated plants: fenugreek powder permits to accelerate plant development; and
the inventors have also discovered another interesting secondary effect regarding the development of mycotoxins (e.g., ochratoxin A): fenugreek powder makes it possible to decrease the rate of mycotoxins in the products obtained after harvesting the treated products (for example, less ochratoxin A is noted in the wine after vine treatment using fenugreek powder).

It is also noted that, according to this invention:
the fenugreek seed powder can come in any formulation: all forms of powder, of pellets (WDG, etc.), containing or not all kinds of added wetting, dispersing or adhering agents or any other formulation product;
the fenugreek powder can be mixed with all other fungicide, bactericide, antiviral, insecticide, plant natural defense stimulating products and/or fertilizers to improve or expand its action;
the active ingredient can be extracted from fenugreek leaves, or from any aerial part of the plant, as well as from its roots;
the fenugreek powder can be solubilized at the time of application onto the plants, but can also be solubilized long before its use, so as to be made available to the users in liquid form; and
the invention concerns the use of fenugreek in the form of dry extract, for example, powder, regardless of the method used to obtain the dry extract and of the extraction method used to obtain this active ingredient.

We claim:

1. Plant treatment product comprising:
a dry product obtained through extraction without liquid from Trigonella foenum graecum (fenugreek).

2. Plant treatment product according to claim 1, wherein said dry product obtained from Trigonella foenum graecum (fenugreek) is mixed with at least one liquid carrier before use.

3. Plant treatment product according to claim 1, wherein said dry product is comprised of at least two active molecules derived from Trigonella foenum graecum.

4. Plant treatment product according to the claim 3, wherein at least one active molecule derived from Trigonella foenum graecum is more than 30,000 Dalton; and wherein at least one active molecule derived from Trigonella foenum graecum is less than 30,000 Dalton.

5. Plant treatment product according to claim 1, wherein said dry product obtained from Trigonella foenum graecum (fenugreek) is, at least in part, obtained from a seed of a fenugreek plant.

6. Plant treatment product according to claim 1, wherein said dry product obtained from Trigonella foenum graecum (fenugreek) is, at least in part, obtained from an aerial part of the fenugreek plant.

7. Plant treatment product according to claim 1, wherein said dry product obtained from Trigonella foenum graecum (fenugreek) is obtained, at least in part, from a root of the fenugreek plant.

8. Plant treatment product according to claim 1, wherein said dry product obtained from Trigonella foenum graecum is formed of powder alone, pellets alone or in combination with other formulation products.

9. Plant treatment product according to claim 1, further comprising: wetting, dispersing and/or adhering agents combined with said dry product obtained from Trigonella foenum graecum.

10. Plant treatment product according to claim 1, further comprising: other treatment products selected from the group consisting of: fungicides, bactericides, antivirals, insecticides, other defense stimulators and/or fertilizers, said other treatment products combined with said dry product obtained from Trigonella foenum graecum.

11. Method of using a plant treatment product according to claim 1, said method comprising steps of:
producing a phytosanitary compound; and
stimulating plant defenses of a plant.

12. Method of using a plant treatment product according to claim 1, said method comprising steps of:
fabricating a phytosanitary compound; and
acting on early development of plants.

13. Method of using a plant treatment product according to claim 1, said method comprising steps of:
producing a phytosanitary compound; and
acting against development of mycotoxins in harvested plants.

14. Method of using a plant treatment product according to claim 1, said method comprising steps of:
producing a phytosanitary compound;
stimulating immune defenses of a plant; and
acting on early development of said plant or on development of mycotoxins.

15. Method to obtain a plant treatment product according to claim 1, said method comprising steps of:
extracting through separation without liquid of a dry product from Trigonella foenum graecum (fenugreek).

16. Method to obtain a plant treatment product according to claim 15, further comprising:
powder reducing a base material.

17. Method to obtain a plant treatment product according to claim 15, further comprising:
crushing a fenugreek seed;
separating a germ and cotyledon fraction from a tegument and biofilm fraction;
re-crushing the germ and cotyledon fraction to obtain a powder of a predetermined grain size storable in a stable manner; and
solubilizing said powder in water.

18. Method to obtain a plant treatment product according to claim 17, further comprising:
screening the germ and cotyledon fraction to obtain particles between 5 microns and 500 microns.
